(19) United States
(12) Patent Application Publication
(10) Pub. No.: US 2014/0176559 A1
(43) Pub. Date: Jun. 26, 2014

(54) IMAGE DISPLAY SYSTEM

(71) Applicant: SAMSUNG DISPLAY CO., LTD., Yongin-City (KR)

(72) Inventors: Hee-Soo Yoo, Yongin-City (KR); Mu Gyeom Kim, Yongin-City (KR); Hyun-Jae Lee, Yongin-City (KR)

(21) Appl. No.: 13/869,249

(22) Filed: Apr. 24, 2013

(30) Foreign Application Priority Data
Dec. 21, 2012 (KR) 10-2012-0150929

(51) Int. Cl. G06T 11/20

(52) U.S. Cl. CPC G06T 11/20
USPC 345/441

(57) ABSTRACT

There is provided an image display system. The image display system comprises an input unit moving to form a first pattern and a display unit displaying an image which comprises a second pattern corresponding to the first pattern. When a size of the first pattern increases, a shape of the second pattern is substantially identical to the whole shape of the first pattern.

This application makes reference to, incorporates the same herein, and claims all benefits accruing under 35 U.S.C. § 119 from an application earlier filed in the Korean Intellectual Property Office on Dec. 21, 2012 and duly assigned Ser. No. 10-2012-0150929.

### BACKGROUND OF THE INVENTION

1. Field of the Invention

Embodiments of the present invention relate to an image display system, and more particularly, to an image display system which displays a pattern formed by the motion of an input unit on a display unit.

2. Description of the Related Art

Tools used to input information to a system include a keyboard, a touch screen panel, a tablet, a mouse, and a wireless pen. Among these tools, the touch screen panel, the tablet, and the mouse can input various patterns through their motion. Therefore, these input tools can be used to draw a picture or write a memo.

If a tablet, a mouse or a wireless pen is used as an input tool, a display unit which displays an image is separated from an information input region. In this case, a pattern formed by the motion of the input tool need to be displayed on the display unit, so that the pattern can be recognized easily by a user.

### SUMMARY OF THE INVENTION

Aspects of the present invention provide an image display system which enables a pattern formed by the motion of an input unit to be recognized easily by a user.

Aspects of the present invention also provide an image display system which enables a user to easily form a desired pattern by moving an input unit.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided an image display system comprising, an input unit moving to form a first pattern and a display unit displaying an image which comprises a second pattern geometrically corresponding to the first pattern. When a size of the first pattern increases, a shape of the second pattern is substantially identical to the whole shape of the first pattern.

According to another aspect of the present invention, there is provided an image display system comprising an input unit moving to form a first pattern and a display unit displaying an image which comprises a second pattern geometrically corresponding to the first pattern. The display unit comprises a pattern display region in which the second pattern is displayed, and the second pattern contacts two opposite sides of a boundary of the pattern display region.

According to another aspect of the present invention, there is provided an image display system comprising an input unit moving to form a first pattern and a display unit displaying an image which comprises a second pattern geometrically corresponding to the first pattern. The display unit comprises a pattern display region in which the second pattern is displayed. The second pattern is split into a plurality of pages when not all of the second pattern can be displayed within the pattern display region after the second pattern is extended.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram of an image display system constructed as an embodiment according to the principles of the present invention;

FIG. 2 is a plan view of a display unit shown in FIG. 1;

FIGS. 3 through 7 are diagrams schematically illustrating the relationship between a first pattern and a second pattern according to an embodiment of the present invention;

FIGS. 8 through 10 are diagrams schematically illustrating the relationship between a first pattern and a second pattern according to another embodiment of the present invention; and

FIGS. 11 through 14 are diagrams schematically illustrating the relationship between a first pattern and a second pattern according to another embodiment of the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Thus, in some embodiments, well-known structures and devices are not shown in order not to obscure the description of the invention with unnecessary detail. Like numbers refer to like elements throughout. In the drawings, the thickness of layers and regions are exaggerated for clarity.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present invention.

Hereinafter, embodiments of the present invention will be described with reference to the attached drawings.

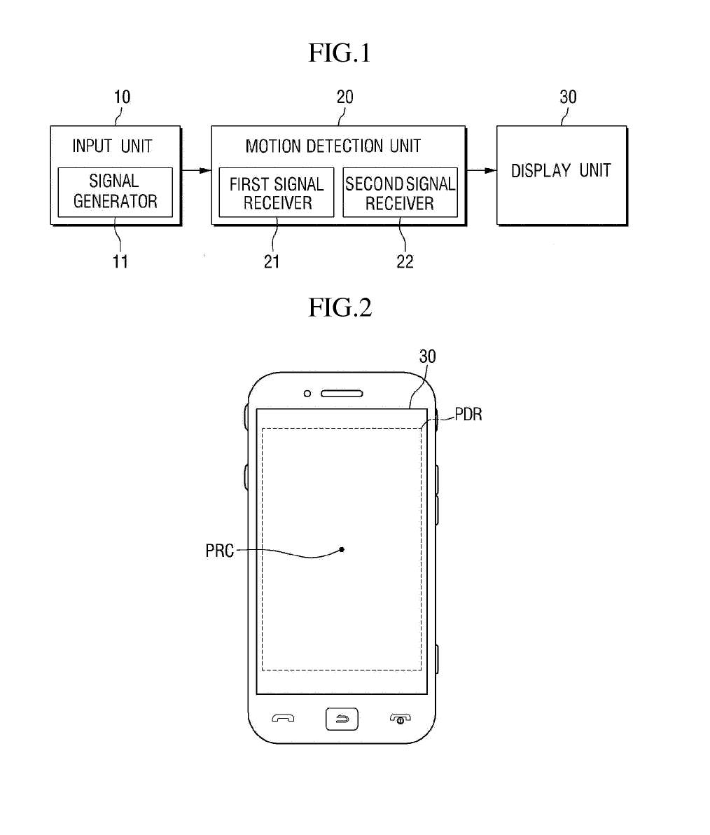

FIG. 1 is a block diagram of an image display system constructed as an embodiment according to the principles of the present invention.

Referring to FIG. 1, the image display system includes an input unit 10 and a display unit 30.

The input unit 10 moves to form a first pattern. The input unit 10 can move freely, and the first pattern can be formed by traces of the movement of the input unit 10. The input unit 10 may form the first pattern in a region of the display unit 30 which is separate from an image display region of the display unit 30. The input unit 10 may be, but is not limited to, a mouse, an electronic pen, or a tablet. The input unit 10 may be connected to the display unit 30 in a wired or wireless manner. The input unit 10 connected to the display unit 30 in a wired or wireless manner may provide information about the first pattern to the display unit 30.

If the input unit 10 is wirelessly connected to the display unit 30, it may include a signal generator 11. The signal generator 11 may generate a reference signal including information about the motion of the input unit 10. The reference signal may be received directly by the display unit 30 or may be received by a motion detection unit 20 which will be described later.

The display unit 30 displays an image including a second pattern which corresponds to the first pattern. The display unit 30 can display a variable image. The display unit 30 may include, but not limited to, a liquid crystal display (LCD) panel, an organic electroluminescence display panel, an electrophoretic display panel, or a plasma display panel. In addition, the display unit 30 can be included in, but not limited to, a monitor, a television, or a smart phone. The display unit 30 will now be described in more detail with reference to FIG. 2. FIG. 2 is a plan view of the display unit 30 shown in FIG. 1.

Referring to FIG. 2, a region of the image display region of the display unit 30 may be designated as a pattern display region PDR. The second pattern may be displayed in the pattern display region PDR. The second pattern may be simultaneously displayed in response to the change of the first pattern. In other words, the second pattern displayed in the pattern display region PDR may be dynamically updated corresponding to the change of the first pattern. According to some embodiments, the entire image display region of the display unit 30 may be designated as the pattern display region PDR. The second pattern may start from a center PRC of the pattern display region PDR. This will be described in detail later.

Referring back to FIG. 1, the image display system may further include the motion detection unit 20. When the input unit 10 is not connected to the display unit 30 in a wired manner, the motion detection unit 20 may detect the motion of the input unit 10. The motion detection unit 20 may detect the motion of the input unit 10 and send information about the detected motion to the display unit 30. The motion detection unit 20 may be connected to the input unit 10 in a wired or wireless manner.

The motion detection unit 20 may include signal receivers 21 and 22. Each of the signal receivers 21 and 22 may receive the reference signal generated by the signal generator 11. The motion detection unit 20 may detect the motion of the input unit 10 based on the reference signal received by each of the signal receivers 21 and 22.

The signal receivers 21 and 22 may include a first signal receiver 21 and a second signal receiver 22. The first signal receiver 21 and the second signal receiver 22 may be separated from each other. Each of the first signal receiver 21 and the second signal receiver 22 may receive the reference signal generated by the signal generator 11 included in the input unit 10. The reference signal received by each of the first signal receiver 21 and the second signal receiver 22 may vary according to a distance between each of the first and second signal receivers 21 and 22 and the input unit 10. The position of the input unit 10 can be identified based on a difference between the reference signal received by the first signal receiver 21 and the reference signal received by the second signal receiver 22. According to some embodiments, the signal receivers 21 and 22 may further include a third signal receiver and a fourth signal receiver.

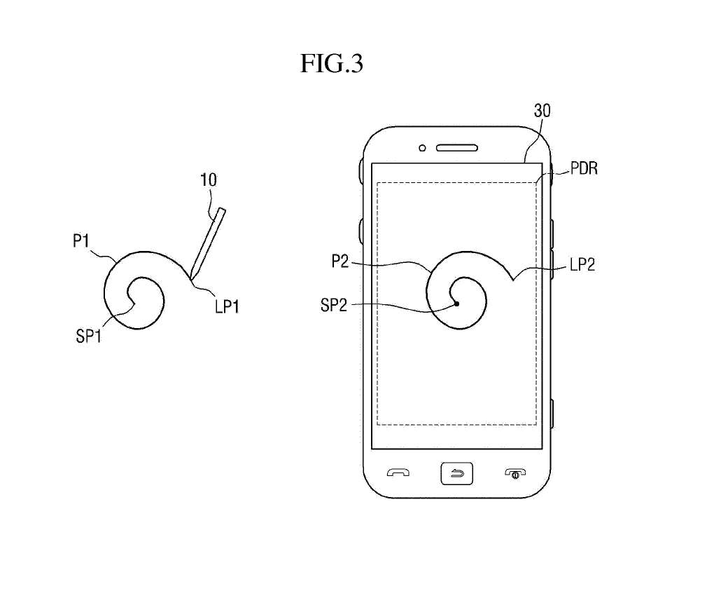

The relationship between the first pattern and the second pattern will now be described with reference to FIGS. 3 through 7. FIGS. 3 through 7 are diagrams illustrating the relationship between a first pattern and a second pattern according to an embodiment of the present invention.

Referring to FIG. 3, a first pattern P1 may include a first start point SP1 and a first end point LP1. The input unit 10 may form the first pattern P1 by moving from the first start point SP1 to the first end point LP1. The first pattern P1 may be defined by a path along which the input unit 10 has moved. The first pattern P1 may not actually be visible and may just be intended to show the path along which the input unit 10 has moved.

A second pattern P2 may be formed in the pattern display region PDR of the display unit 30. A shape of the second pattern P2 may correspond to a shape of the first pattern P1. Although a size of the second pattern P2 may be different from that of the first pattern P1, the shape of the second pattern P2 may be substantially identical to that of the first pattern P1.

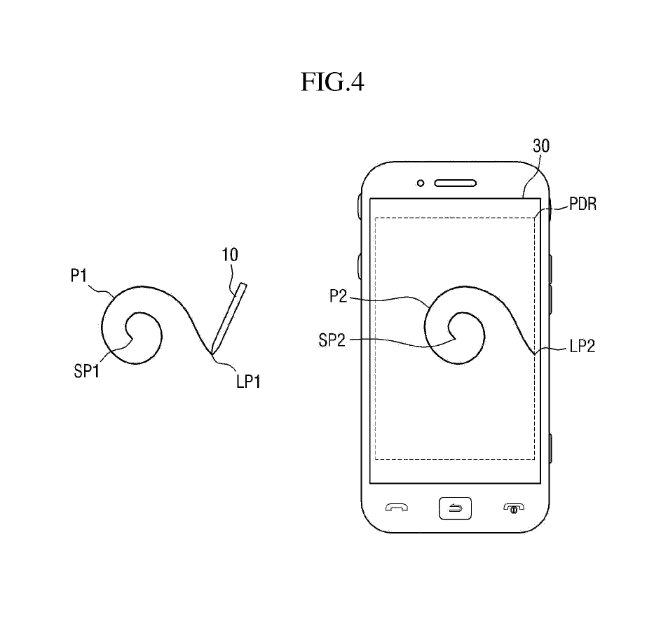

The second pattern P2 may include a second start point SP2 and a second end point LP2. The second start point SP2 may correspond to the first start point SP1 of the first pattern P1. The second end point LP2 may correspond to the first end point LP1 of the first pattern P1. The second start point SP2 may be a portion of the second pattern P2 which is formed first. The second end point LP2 may be a portion of the second pattern P2 which is formed last. The second pattern P2 may be formed from the second start point SP2 to the second end point LP2 such that it corresponds to the first pattern P1. The position of the second start point SP2 may be the same as the center PDRC of the pattern display region PDR of FIG. 2. In FIGS. 4 through 7, the position of the second start point SP2 may also be the same as the center PDRC of the pattern display region PDR. The position of the second start point SP2 may not be changed.

While the second pattern P2 is not in contact with a boundary of the pattern display region PDR, a ratio of the size of the second pattern P2 to the size of the first pattern P1 may be maintained constant. That is, while a trace of the second end point LP2 is not in contact with the boundary of the pattern display region PDR, the ratio of the size of the second pattern P2 to the size of the first pattern P1 may be maintained constant.

Referring to FIG. 4, the input unit 10 may move additionally in the state of FIG. 3, thereby extending the first pattern P1. The first end point LP1 may be extended up to a point where the second end point LP2 corresponding to the first end point LP1 reaches the boundary of the pattern display region PDR. Until the second end point LP2 reaches the boundary of the pattern display region PDR, the ratio of the size of the second pattern P2 to the size of the first pattern P1 may be maintained constant.

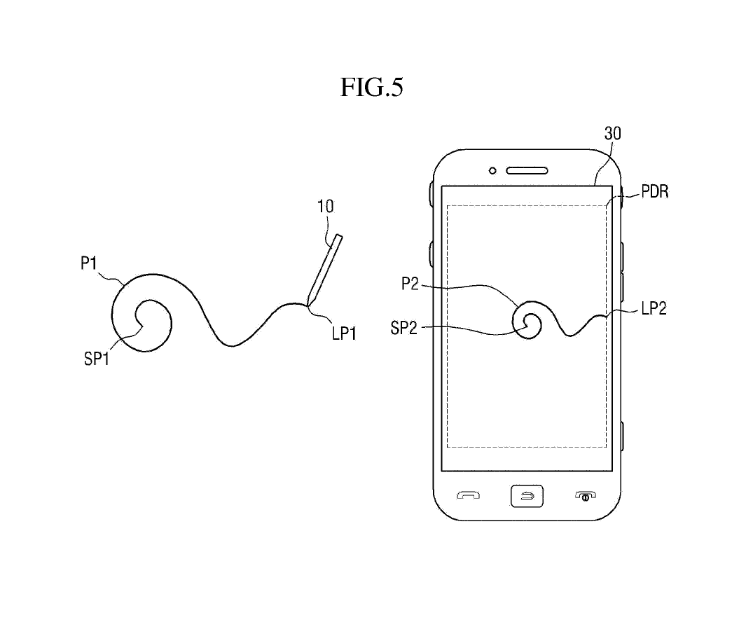

Referring to FIG. 5, the input unit 10 may move additionally in the state of FIG. 4, thereby further extending the first pattern P1. In a state where the second end point LP2 is in contact with the boundary of the pattern display region PDR, the first pattern P1 may be extended such that the second pattern P2 will be extended outside the boundary of the pattern display region PDR if the ratio of the size of the second pattern P2 to the size of the first pattern P1 is maintained at the ratio of FIG. 4. In this case, the second end point LP2 may continuously be in contact with the boundary of the pattern display region PDR. The second pattern P2 may represent the whole shape of the first pattern P1 within the pattern display region PDR. In order for the second pattern P2 to represent the whole shape of the first pattern P1 within the pattern display region PDR, the ratio of the size of the second pattern P2 to the size of the first pattern P1 may be continuously reduced. Therefore, in the image display system according to the current embodiment, even if the size of the first pattern P1 formed by the motion of the input unit 10 increases, the shape of the first pattern P1 can entirely be displayed on the display unit 30. Accordingly, a user can easily recognize the shape of the first pattern P1 formed by the motion of the input unit 10. Furthermore, since the shape of the first pattern P1 can be recognized easily, the user can conveniently form the first pattern P1 as desired.

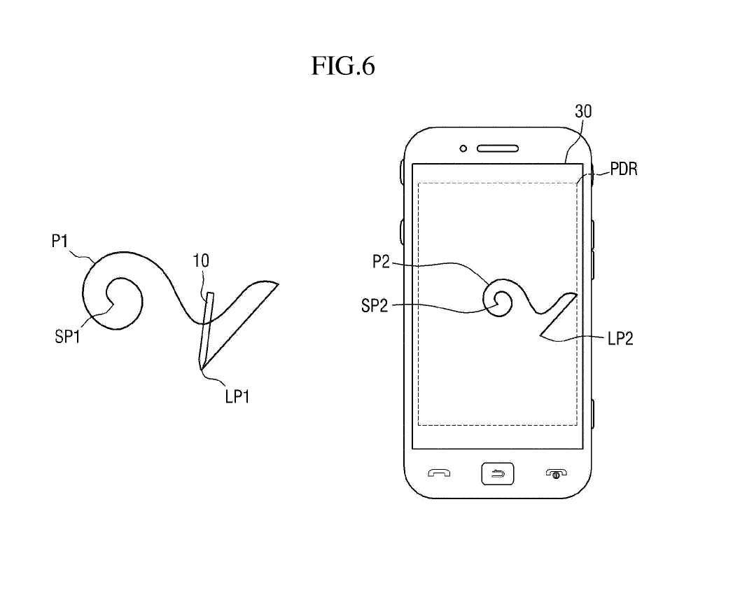

Referring to FIG. 6, the input unit 10 may move additionally in the state of FIG. 5, thereby extending the first pattern P1. In the state where the second end point LP2 is in contact with the boundary of the pattern display region PDR as in FIG. 5, the first pattern P1 may be extended such that the second pattern P2 is extended inside the pattern display region PDR. When the second end point LP2 is in contact with the boundary of the pattern display region PDR, if the second pattern P2 is extended inside the pattern display region PDR, the ratio of the size of the second pattern P2 to the size of the first pattern P1 may not be changed.

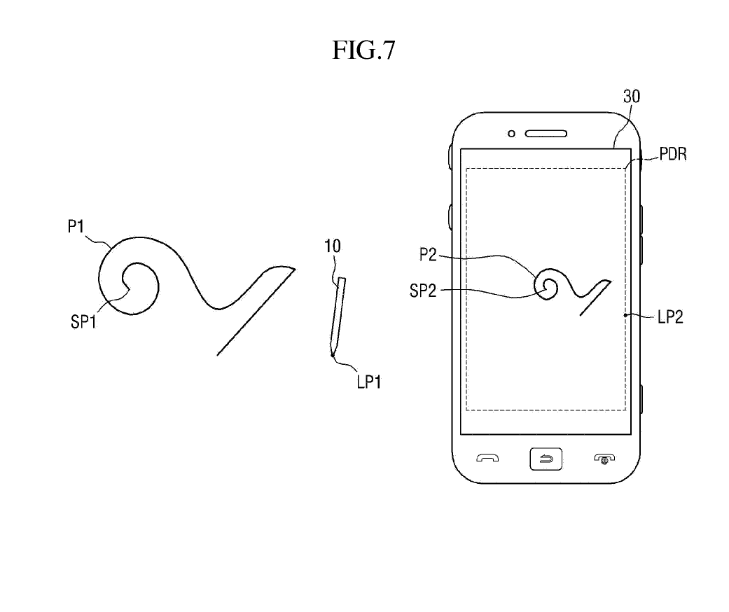

Referring to FIG. 7, the input unit 10 may form another first pattern P1 from a point separated from the existing first pattern P1 of FIG. 6. According to some embodiments, the input unit 10 may include a switch which can control the formation of the first pattern P1. Thus, the input unit 10 may form another first pattern P1 separated from the existing first pattern P1 by controlling the switch. According to some other embodiments, the display unit 30 may control the formation of the first pattern P1. The method of forming another first pattern P1 separated from the existing first pattern P1 is not limited to these methods.

When another first pattern P1 is formed from a point separated from the existing first pattern P1, the first end point LP1 may be formed such that the second end point LP2 corresponding to the first end point LP1 cannot be formed within the pattern display region PDR if the ratio of the size of the second pattern P2 to the size of the first pattern P1 is maintained at the ratio of FIG. 6. In this case, the ratio of the size of the second pattern P2 to the size of the first pattern P1 may be reduced, so that the second end point LP2 can be formed within the pattern display region PDR. The second end point LP2 may be in contact with the boundary of the pattern display region PDR.

Although not show in the drawing, when another first pattern P1 is formed from a point separated from the existing first pattern P1, the first end point LP1 may also be formed such that the second end point LP2 corresponding to the first end point LP1 can be formed within the pattern display region PDR even if the ratio of the size of the second pattern P2 to the size of the first pattern P1 is maintained at the ratio of FIG. 6. In this case, the ratio of the size of the second pattern P2 to the size of the first pattern P1 may not be changed.

As described above with reference to FIGS. 3 through 7, the image display system constructed as the current embodiment according to the principles of the present invention can display the whole shape of the first pattern P1 on the display unit 30 even if the size of the first pattern P1 formed by the motion of the input unit 10 increases. Therefore, a user can easily recognize the shape of the first pattern P1 formed by the motion of the input unit 10. Furthermore, since the shape of the first pattern P1 can be recognized easily, the user can form the first pattern P1 as desired.

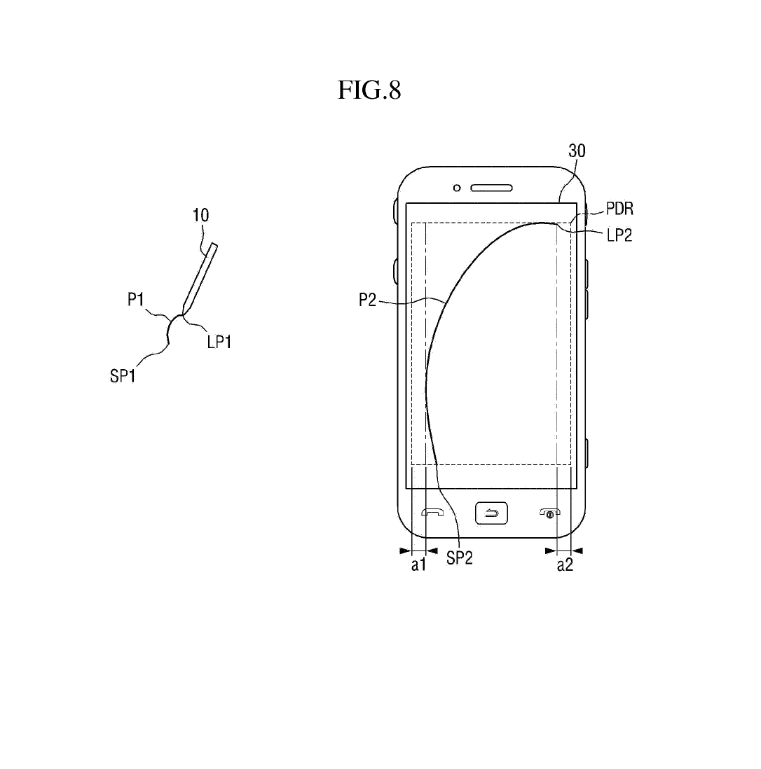

Another embodiment of the present invention will now be described with reference to FIGS. 8 through 10. FIGS. 8 through 10 are diagrams illustrating the relationship between a first pattern and a second pattern according to another embodiment of the present invention.

Referring to FIG. 8, a display unit 30 may display a second pattern P2 which includes the whole shape of a first pattern P1 within a pattern display region PDR. The second pattern P2 may contact two different sides, for instance, two opposite sides, of a boundary of the pattern display region PDR. For example, as shown in FIG. 8, the second pattern P2 may contact upper and lower sides of the boundary of the pattern display region PDR. To make the second pattern P2 contact two opposite sides of the boundary of the pattern display region PDR, the display unit 30 may increase or reduce a ratio of a size of the second pattern P2 to a size of the first pattern P1.

The second pattern P2 may not contact two opposite sides of the boundary of the pattern display region PDR. For example, as shown in FIG. 8, the second pattern P2 may not contact right and left sides of the boundary of the pattern display region PDR. A distance a1 between the left side of the boundary of the pattern display region PDR and the second pattern P2 may be equal to a distance a2 between the right side of the boundary of the pattern display region PDR and the second pattern P2. If the distance a1 between the left side of the boundary of the pattern display region PDR and the second pattern P2 is equal to the distance a2 between the right side of the boundary of the pattern display region PDR and the second pattern P2, the second pattern P2 may be placed in a center of the pattern display region PDR. Therefore, the second pattern P2 can be recognized easily by a user.

Although not shown in the drawing, a value of the ratio of the size of the second pattern P2 to the size of the first pattern P1 can be adjusted to make the second pattern P2 contact the left and right sides of the boundary of the pattern display region PDR. Here, if the second pattern P2 does not contact the upper and lower sides of the boundary of the pattern display region PDR, the second pattern P2 may be displayed such that it contacts the left and right sides of the boundary of the pattern display region PDR. In this case, a distance from the upper side of the boundary of the pattern display region PDR to the second pattern P2 may be equal to a distance from the lower side of the boundary of the pattern display region PDR to the second pattern P2.

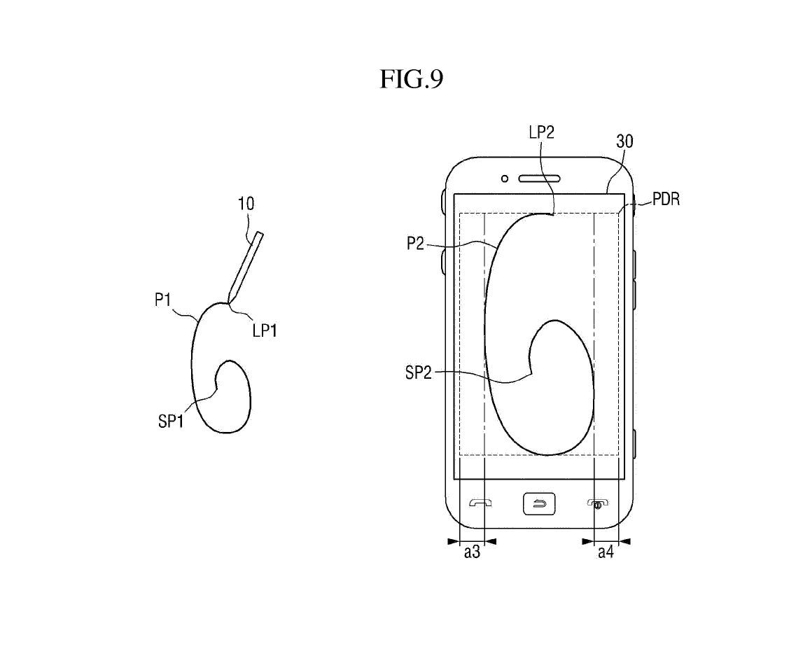

Referring to FIG. 9, the first pattern P1 may be extended from the one shown in FIG. 8. Thus, horizontal and vertical widths of the first pattern P1 may increase. That is, the first pattern P1 may become larger. Even if the size of the first pattern P1 increases, the display unit 30 can display the second pattern P2 including the whole shape of the first pattern P1 within the pattern display region PDR. When the size of the first pattern P1 increases, the ratio of the size of the second pattern P2 to the size of the first pattern P1 may be reduced, so that the second pattern P2 including the whole shape of the first pattern P1 can be displayed within the pattern display region PDR.

Even if the size of the first pattern P1 increases, the second pattern P2 may contact two opposite sides of the boundary of the pattern display region PDR. For example, as shown in FIG. 9, the second pattern P2 may contact the upper and lower sides of the boundary of the pattern display region PDR.

Even if the size of the first pattern P1 increases, the second pattern P2 may not contact two opposite sides of the boundary of the pattern display region PDR. For example, as shown in FIG. 9, the second pattern P2 may not contact the right and left sides of the boundary of the pattern display region PDR. A distance a3 between the left side of the boundary of the pattern display region PDR and the second pattern P2 may be equal to a distance a4 between the right side of the boundary of the pattern display region PDR and the second pattern P2. If the distance a3 between the left side of the boundary of the pattern display region PDR and the second pattern P2 is equal to the distance a4 between the right side of the boundary of the pattern display region PDR and the second pattern P2, the second pattern P2 may be placed in the center of the pattern display region PDR. Therefore, the second pattern P2 can be recognized easily by the user.

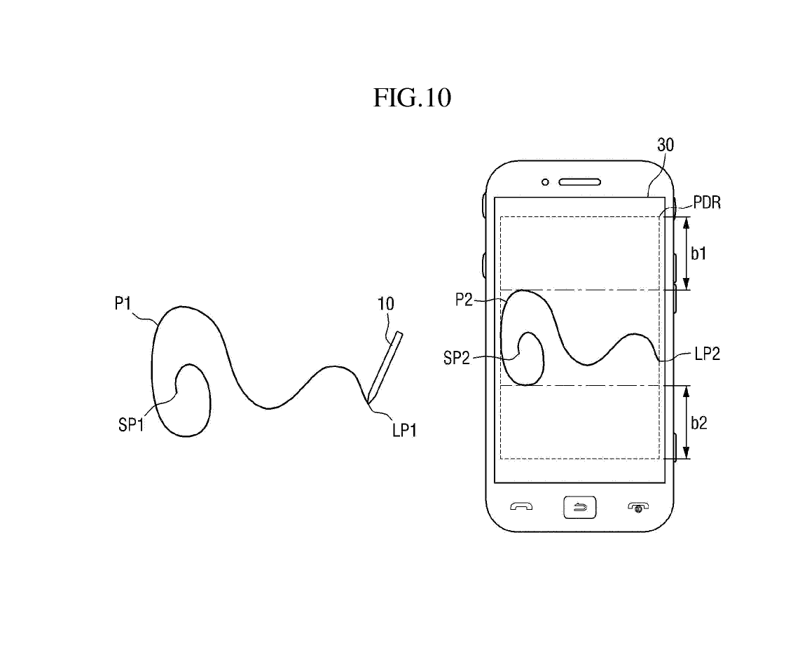

Referring to FIG. 10, the first pattern P1 may be further extended from the one shown in FIG. 9. Thus, the first pattern P1 may become larger. In particular, the horizontal width of the first pattern P1 may increase. Even if the size of the first pattern P1 increases, the display unit 30 can display the second pattern P2 including the whole shape of the first pattern P1 within the pattern display region PDR. When the size of the first pattern P1 increases, the ratio of the size of the second pattern P2 to the size of the first pattern P1 may be reduced, so that the second pattern P2 including the whole shape of the first pattern P1 can be displayed within the pattern display region PDR.

As shown in FIG. 10, the value of the ratio of the size of the second pattern P2 to the size of the first pattern P1 can be adjusted to make the second pattern P2 contact the left and right sides of the boundary of the pattern display region PDR. Here, if the second pattern P2 does not contact the upper and lower sides of the boundary of the pattern display region PDR, the second pattern P2 may be displayed such that it contacts the left and right sides of the boundary of the pattern display region PDR.

When the second pattern P2 contacts the left and right sides of the boundary of the pattern display region PDR, it may not contact the upper and lower sides of the boundary of the pattern display region PDR. In this case, a distance b1 between the upper side of the boundary of the pattern display region PDR and the second pattern P2 may be equal to a distance b2 between the lower side of the boundary of the pattern display region PDR and the second pattern P2. If the distance b1 between the upper side of the boundary of the pattern display region PDR and the second pattern P2 is equal to the distance b2 between the lower side of the boundary of the pattern display region PDR and the second pattern P2, the second pattern P2 may be placed in the center of the pattern display region PDR. Therefore, the second pattern P2 can be recognized easily by the user.

As described above with reference to FIGS. 8 through 10, an image display system constructed as the current embodiment according to the principles of the present invention makes the second pattern P2 contact at least two sides of the boundary of the pattern display region PDR. Accordingly, the image display system constructed as the current embodiment according to the principles of the present invention can display the second pattern P2 at a maximum displayable size as long as a ratio of the horizontal and vertical widths of the second pattern P2 is equal to that of the horizontal and vertical widths of the first pattern P1. Furthermore, the image display system constructed as the current embodiment can display the second pattern P2 in the center of the pattern display region PDR by maintaining the second pattern P2 at equal distances from two sides of the boundary of the pattern display region PDR which do not contact the second pattern P2. Therefore, the image display system constructed as the current embodiment can display the whole first pattern P1 at a maximum possible size in the center of the pattern display region PDR, so that a user can easily recognize the first pattern P1. In addition, since the first pattern P1 can be recognized easily by the user, the user can form the first pattern P1 as desired.

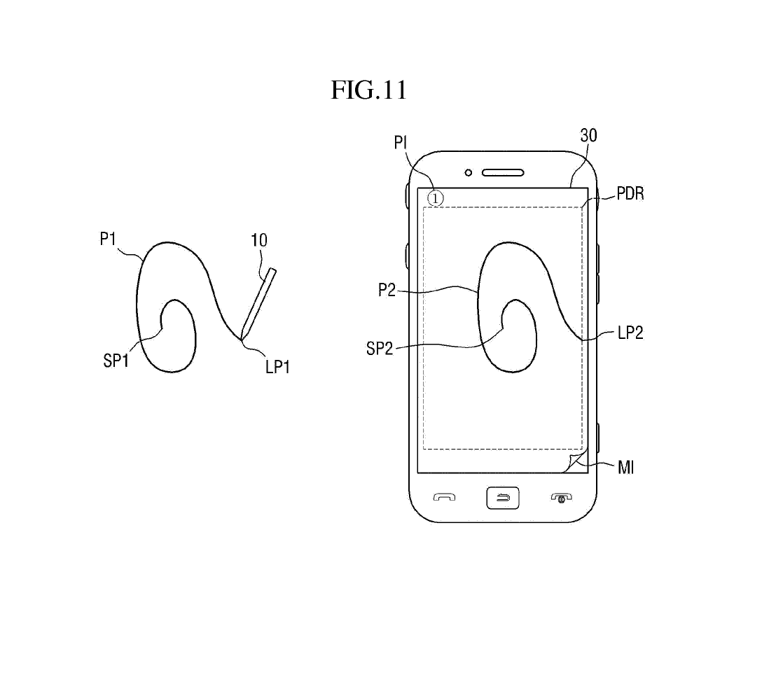

Another embodiment of the present invention will now be described with reference to FIGS. 11 through 14. FIGS. 11 through 14 are diagrams illustrating the relationship between a first pattern and a second pattern according to another embodiment of the present invention.

Referring to FIG. 11, a first pattern P1 may be extended until a second end point LP2 contacts a boundary of a pattern display region PDR. The first pattern P1 and a second pattern P2 shown in FIG. 11 may be substantially identical to the first pattern P1 and the second pattern P2 shown in FIG. 4. In the embodiment of FIGS. 11 through 14, a ratio of a size of the second pattern P2 to a size of the first pattern P1 may not be changed.

A display unit 30 may further include a page identifier PI in an image display region thereof. The page identifier PI may indicate a page of an image including the second pattern P2 which is currently being displayed in the pattern display region PDR. Pages may be numbered in order of creation. In FIG. 11, the page identifier PI corresponding to a first page is shown. In FIG. 11, the page identifier PI is displayed outside the pattern display region PDR. However, according to some embodiments, the page identifier PI may be displayed inside the pattern display region PDR.

The display unit 30 may further include a mode indicator MI in the image display region. The mode indicator MI may indicate that an image display system is operating according to the embodiment of FIGS. 11 through 13. A specific shape of the mode indicator MI can vary depending on embodiments.

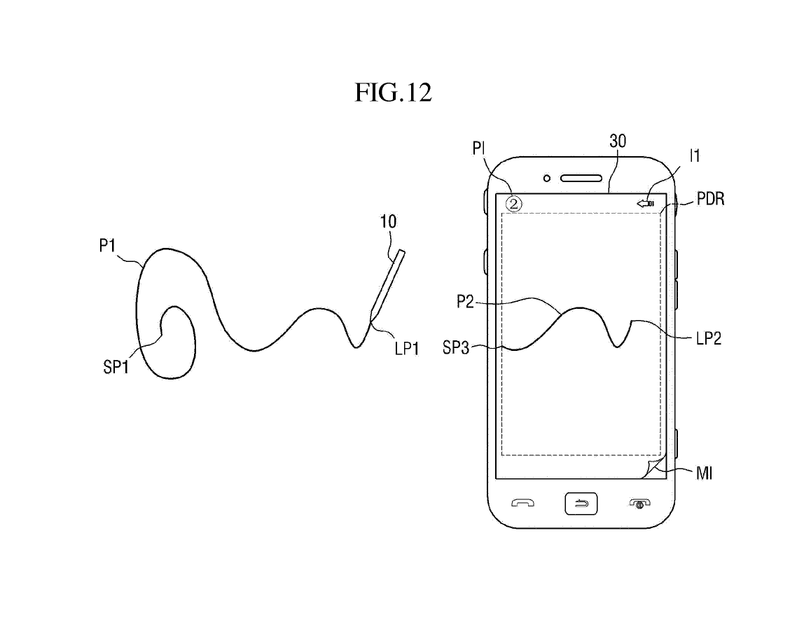

Referring to FIG. 12, the first pattern P1 may be formed such that the second pattern P2 of FIG. 11 is extended outside the pattern display region PDR. In this case, the image display system may create another page. Therefore, an additional region of the second pattern P2 which is not displayed within the pattern display region PDR of FIG. 11 may be formed in the new page, and the display unit 30 may display the new page. For example, as shown in FIG. 12, the image display system may create a second page. In this case, the page identifier PI may be changed to correspond to the second page, and a region of the second pattern P2 which corresponds to the second page may be displayed in the pattern display region PDR. When the region of the second pattern P2 which corresponds to the second page is displayed in the pattern display region PDR, the second pattern P2 of the second page may be formed by a path along which the second end point LP2 has moved from a third start point SP3. The third start point SP3 may contact a side of the boundary of the pattern display region PDR. If the first page is placed to contact the side of the boundary of the pattern display region PDR, the third start point SP3 may be connected to the second pattern P2 of the first page.

The display unit 30 may further include a first direction indicator DI1 in the image display region. The first direction indicator DI1 may indicate a direction in which a previous page of a page currently being displayed in the pattern display region PDR is located. For example, as shown in FIG. 12, if the second page is currently being displayed in the pattern display region PDR, the first direction indicator DI1 may indicate a direction in which the first page is located. A direction indicated by the first direction indicator DI1 may be from a center of the pattern display region PDR toward a side of the boundary of the pattern display region PDR which is in contact with a portion of the second pattern P2 which was formed first in a current page. For example, in FIG. 12, the direction indicated by the first direction indicator DI1 may be from the center of the pattern display region PDR toward a side of the pattern display region PDR which is in contact with the third start point SP3.

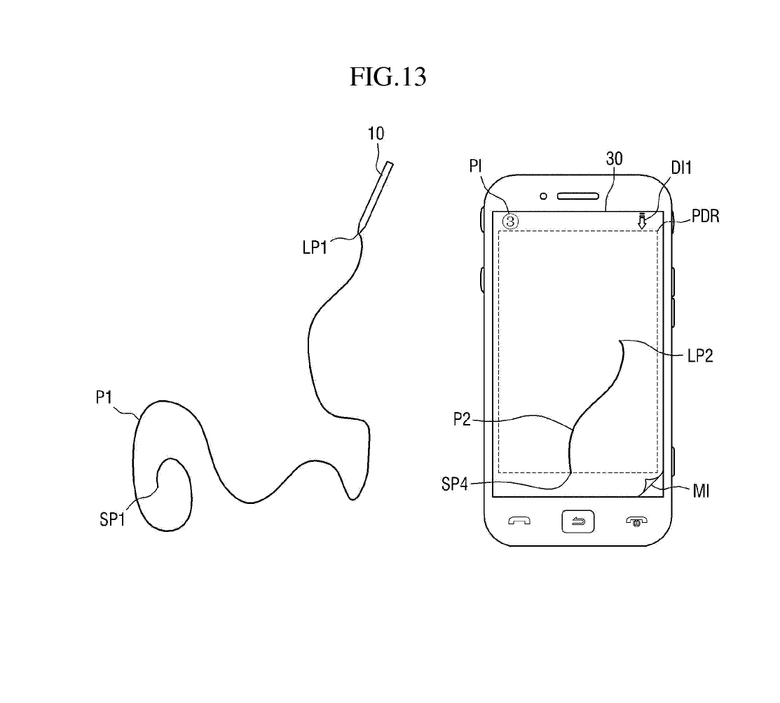

Referring to FIG. 13, the first pattern P1 may be formed such that the second pattern P2 of FIG. 12 is extended beyond an upper side of the boundary of the pattern display region PDR. In this case, the image display system may create a third page, and the display unit 30 may display a region of the second pattern P2 which corresponds to the third page. Accordingly, the page identifier PI may be changed to correspond to the third page. The second pattern P2 of the third page may be formed by a path along which the second end point LP2 has moved from a fourth start point SP4. The fourth start point SP4 may contact a lower side of the boundary of the pattern display region PDR. If the second page which is a previous page of the third page currently being displayed is placed to contact the lower side of the boundary of the pattern display region PDR, the fourth start point SP4 may be connected to the second pattern P2 of the second page.

The page identifier PI may be changed to correspond to the third page, and a region of the second pattern P2 which corresponds to the third page may be displayed in the pattern display region PDR. When the region of the second pattern P2 which corresponds to the third page is displayed in the pattern display region PDR, the second pattern P2 of the third page may be formed by the path along which the second end point LP2 has moved from the fourth start point SP4. The fourth start point SP4 may contact a side of the boundary of the pattern display region PDR. If the second page is placed to contact the side of the boundary of the pattern display region PDR, the fourth start point SP4 may be connected to the second pattern P2 of the second page.

The first direction indicator DI1 may indicate a direction in which the second page is located from the third page currently being displayed. A direction indicated by the first direction indicator DI1 may be from the center of the pattern display region PDR toward a side of the boundary of the pattern display region PDR which is in contact with a portion of the second pattern P2 which was formed first in the third page. That is, the direction indicated by the first direction indicator DI1 may be from the center of the pattern display region PDR toward a side of the pattern display region PDR which is in contact with the fourth start point SP4. The first direction indicator DB may be located outside the pattern display region PDR. Although not shown in the drawing, according to some embodiments, the first direction indicator DI1 may be located inside the pattern display region PDR.

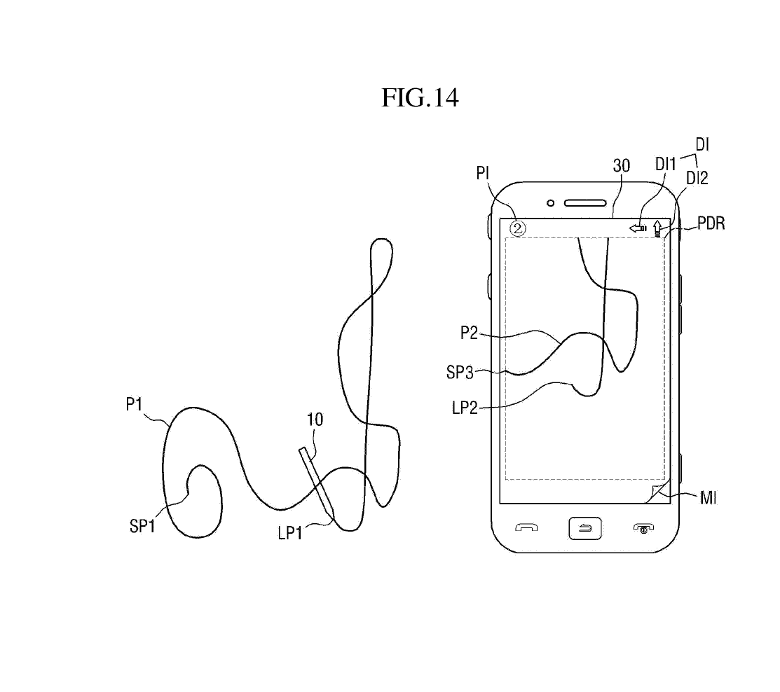

Referring to FIG. 14, the first pattern P1 may be formed such that the second pattern P2 is extended in a direction toward the previous page of the page displayed in FIG. 13. That is, the second pattern P2 may be extended beyond the lower side of the boundary of the pattern display region PDR in FIG. 13. In this case, a region of the second pattern P2 which corresponds to the second page may be displayed in the pattern display region PDR.

The display unit 30 may further include a second direction indicator DI2 in the image display region. The second direction indicator DI2 may indicate a direction in which a next page of a currently displayed page is located. In FIG. 14, the second direction indicator DI2 may indicate a direction in which the third page created immediately after the second page currently being displayed in the pattern display region PDR is located. That is, a direction indicated by the second direction indicator DI2 may be from the center of the pattern display region PDR toward the upper side of the boundary of the pattern display region PDR. To be distinguished from each other, the first direction indicator DI1 and the second direction indicator DI2 may have different colors or may be located at different designated positions. If there is no page after a current page, the second direction indicator DI2 may not be displayed. The second direction indicator DI2 may be located outside the pattern display region PDR. Although not shown in the drawing, according to some embodiments, the second direction indicator DI2 may be located inside the pattern display region PDR.

The image display system according to the embodiment of FIGS. 11 through 14 splits the second pattern P2 to display the second pattern P2 without changing a ratio of a size of the second pattern P2 to a size of the first pattern P1. Therefore, the first pattern P1 can be recognized easily by a user, and thus the user can form the first pattern P1 as desired.

Although not shown in the figures, the display system constructed as the aforementioned embodiments may further include a controller which receives the reference signals from the motion detection unit 20 and correspondingly generates a control signal. Accordingly, the display unit 30 receives the control signal provided by the controller and correspondingly adjusts the second pattern P2 displayed on the pattern display region PDR. The adjustments controlled by the controller may include repositioning the second pattern P2, scaling/resizing the second pattern P2, and splitting the second pattern P2 in response to the dynamic change of the first pattern P1. Alternatively, the display unit 30 may include the controller. The detailed operations of the display system will be omitted here in order not to repeat the same description.

Embodiments of the present invention provide at least one of the following advantages.

That is, a pattern displayed on a display device formed by the motion of an input unit can be recognized easily.

In addition, since a pattern formed by the motion of the input unit can be recognized easily, a user can form a desired pattern conveniently.

However, the effects of the present invention are not restricted to the one set forth herein. The above and other effects of the present invention will become more apparent to one of daily skill in the art to which the present invention pertains by referencing the claims.

What is claimed is:

1. An image display system, comprising:
an input unit responding to movement by forming a first pattern; and
a display unit displaying an image which comprises a second pattern geometrically corresponding to the first pattern, and maintaining a shape of the second pattern substantially identical to the whole shape of the first pattern when the first pattern increases in size in response to an extension of the movement of the input unit.

2. The image display system of claim 1, wherein the display unit comprises a pattern display region, the second pattern is displayed within the pattern display region, and a ratio of a size of the second pattern to the size of the first pattern is not reduced when the second pattern does not contact a boundary of the pattern display region.

3. The image display system of claim 2, wherein when the second pattern reaches the boundary of the pattern display region and when the first pattern is extended such that the second pattern is extended outside the boundary of the pattern display region reached by the second pattern, the ratio of the second pattern to the size of the first pattern is reduced.

4. The image display system of claim 3, wherein the second pattern comprises a second start point which is formed first and a second end point which is formed last, wherein when the second pattern reaches the boundary of the pattern display region and when the first pattern is extended such that the second pattern is extended outside the boundary of the pattern display region reached by the second pattern, the second end point is placed on the boundary of the pattern display region.

5. The image display system of claim 2, wherein the first pattern comprises a first start point which is formed first and a first end point which is formed last, wherein the second pattern comprises a second start point corresponding to the first start point and a second end point corresponding to the first end point, and the second start point is displayed at a center of the pattern display region.

6. An image display system, comprising:
an input unit responding to movement by forming a first pattern; and
a display unit displaying an image which comprises a second pattern geometrically corresponding to the first pattern,
the display unit comprising a pattern display region in which the second pattern is displayed, and the second pattern contacting a first pair of opposite sides of a boundary of the pattern display region.

7. The image display system of claim 6, wherein the boundary of the pattern display region is a quadrangle including the first pair of opposite sides and a second pair of opposite sides.

8. The image display system of claim 7, wherein the second pattern does not contact the second pair of opposite sides of the boundary of the pattern display region.

9. The image display system of claim 8, wherein each of the second pair of opposite sides has a same distance from the second pattern.

10. An image display system, comprising:
an input unit responding to movement by forming a first pattern; and
a display unit displaying an image which comprises a second pattern geometrically corresponding to the first pattern,
the display unit comprising a pattern display region in which the second pattern is displayed, and the second pattern split into a plurality of pages when the second pattern cannot be completely displayed within the pattern display region after the second pattern is extended.

11. The image display system of claim 10, wherein when a size of the first pattern is changed, a ratio of a size of the second pattern to the size of the first pattern is not changed.

12. The image display system of claim 10, wherein when the second pattern is split into the pages, the pages comprise a recently created new page, and the display unit displays the new page.

13. The image display system of claim 10, wherein the pages comprise a first page created first, the first pattern comprises a first start point which is formed first and a first end point which is formed last, the second pattern comprises a second start point corresponding to the first start point and a second end point corresponding to the first end point, and a region of the second pattern included in the first page comprises the second start point.

14. The image display system of claim 13, wherein when the first page is displayed in the pattern display region, the first start point is displayed at a center of the pattern display region.

15. The image display system of claim 10, wherein the display unit further comprises a page identifier which displays information about a page currently being displayed in the pattern display region.

16. The image display system of claim 15, wherein the page identifier is located outside the pattern display region.

17. The image display system of claim 10, wherein the display unit further comprises a first direction indicator indicating a direction in which a page created immediately before the page currently being displayed in the pattern display region is located.

18. The image display system of claim 17, wherein a direction indicated by the first direction indicator is from the center of the pattern display region toward a side of a boundary of the pattern display region which is in contact with a portion of the second pattern which was formed first in the page currently being displayed in the pattern display region.

19. The image display system of claim 18, wherein the display unit further comprises a second direction indicator indicating a direction in which a page created immediately after the page currently being displayed in the pattern display region is located.

20. The image display system of claim 19, wherein the first direction indicator and the second direction indicator are located outside the pattern display region.
